(19) United States
(12) Patent Application Publication
(10) Pub. No.: US 2015/0178694 A1
(43) Pub. Date: Jun. 25, 2015

(54) RF PAYMENT TERMINAL FOR SCRIPT FILE-BASED CREDIT CARD PROCESSING

(71) Applicant: Korea Smart Card Co., Ltd., Seoul (KR)

(72) Inventors: Byung Geun Chang, Gyeonggido (KR); Hyun Woo Nam, Seoul (KR)

(21) Appl. No.: 14/409,752

(22) PCT Filed: May 7, 2013
(86) PCT No.: PCT/KR2013/003977

§ 371 Date: Dec. 19, 2014

(30) Foreign Application Priority Data
Jun. 20, 2012 (KR) 10-2012-0066384

(51) Int. Cl. G06Q 20/08; G06F 9/45; G06Q 20/34

(52) U.S. Cl. CPC G06Q 20/08; G06Q 20/34; G06F 8/41

(57) ABSTRACT

The present invention relates to a method for controlling a terminal including a script engine which provides a credit card processing object. The method includes the steps of: loading a script including code for calling a credit card processing object; and controlling the device driver of the terminal by executing the script using the script engine. Here, the credit card processing object can include a function for controlling the device driver.

### TECHNICAL FIELD

The present invention relates to a technology for a radio frequency (RF) payment terminal, and more particularly, to a script-based technology.

### BACKGROUND ART

A radio frequency (RF) payment terminal (hereinafter, referred to simply as “terminal”) includes an execution file that accesses a memory of various types of RF card products holding various items and performs processing on a corresponding item. Also, the terminal may include various application function modules for supporting electronic payment using a card, such as card validity check, security and communication interface modules. In this case, when a new card product or item is added, there is a need to change a program of the terminal so that the terminal may additionally perform a new application function for processing an added product or item.

Functions of various applications included in the terminal may depend on the hardware or operating system (OS) of the terminal in configuration and are being written in a low level language such as C or C++ due to performance issue. A program written with such a language is being implemented in a static execution file format created through a compile process. When there is a need to update the function of the terminal, the source code of an application is modified and a build operation is re-performed. By copying an execution file created through the compile process to the terminal, then closing an execution file of an application being executed, and re-executing a copied software execution file, it is possible to update the function of the terminal. Thus, the terminal does not operate during the installation and re-execution processes of an application.

Card processing terminals may be divided into a payment terminal, a charging terminal, and a search terminal. For example, the payment terminal has bee developed in various forms for bus fare, taxi fare, and/or subway fare, and general payment. When an application of each terminal is developed, the same card processing function has been independently developed so far for each type of terminal or each manufacturing company and as a result, the same function has been implemented and optimized in different manners for each terminal. For example, payment terminals performing the same payment function have been individually developed depending on a manufacturing company or a type of terminal and in addition, various source codes have been created even when the card payment of the same company holing the same item is processed. In this case, since various codes performing the same function are created, it is difficult to manage quality and redundant effort and cost have been needed.

### DISCLOSURE OF THE INVENTION

### Technical Problem

Typically, a source code has been modified to add or change a function of a terminal and then a compile process has been performed. To this end, each time a function is added or changed, a new execution file has been built. Thus, in order to update some functions, the whole application has needed to be newly compiled. That is, since the whole application is affected even when only some functions are changed, it was difficult to configure a flexible system.

The present invention provides a terminal technology that may dynamically add and change a function of an application of a radio frequency (RF) payment terminal by only a script file download without the compilation, installation and re-execution steps of source code.

### Technical Solution

The present invention provides a system structure and processing method may process, functions of card processing modules written in C or C++ among functions of a terminal application, by using script files.

To this end, payment, charging, transactional information check, balance check, and service change functions through RF card processing of a terminal are provided with script based modules. As a result, even if an application is not modified, it is possible to use various card processing functions by applying a script having a desired function.

Thus, the terminal is not limited to any one of e.g., payment, charging and check functions, and may freely perform one or more functions according to a loaded script. Also, even when there is a need for version-up or patch to update a function of the terminal, it is possible to flexibly add or change the function of the terminal by replacing only a script without stopping a system.

To this end, the present invention proposes a system configuration for an application and a script processing method. In particular, when a card type or item capable of being supported at a payment terminal having an RF card processing function is added, update is completed by only replacing with an updated script.

According to an embodiment of the present invention, the terminal downloads a script file specifying processing code for a specific function, loads the script file in an internal memory and then executes the script file when a corresponding function is requested. Thus, there is no need for a series of processes of modifying and then compiling source code in order to modify the function of an application and installing execution binary in the terminal, which are needed by a typical terminal. As a result, since there is no need for a compilation process, it is possible to perform a desired function by dynamically replacing a script even while the terminal operates. In addition, even when the application is not changed, a function change may be completed by replacing only a corresponding script. Thus, an update is possible without stopping the system, which is difficult in a typical system, and effort and time consumed for the update are saved in comparison to the typical system.

According to an embodiment of the present invention, since card processing functions such as payment and charging functions are written in a script file, which is then provided to any terminal including a script engine for performing the functions and a related device interface, any terminal may perform corresponding functions with one and the same script file.

Also, according to an embodiment of the present invention, a general-purpose terminal perform various functions such as payment and charging functions by using a script engine and a card processing related module. Thus, according to the present invention, it is possible to use a terminal only for a special purpose or for a general purpose such as PC. For example, when the terminal is manufactured for the general purpose and includes an RF tag module and a SAM module, it is possible to perform various functions by downloading only a script needed for driving the modules from a server.

According to an embodiment of the present invention, even if a new card type or card item is released, it is possible to flexibly update without stopping a system because downloading only a script file capable of processing a corresponding card or item is needed for replacement.

Also, unlike a typical terminal that may execute only an application developed for a dedicated use, it is possible to change a terminal to a payment terminal or charging terminal depending on a type of script loaded onto the terminal by using a script engine capable of interpreting and executing a script file.

According to an aspect of the present invention, it is possible to provide a method of controlling a terminal including a script engine providing a card processing object. The method includes loading a script including code calling a card processing object, at a terminal including a script engine providing the card processing object; and executing the script by using the script engine at the terminal to control a device driver of the terminal.

The card processing object may include a function for controlling the device driver.

The function may be described in a Compiled language.

The card processing object may be formed by a Compiled language.

The card processing object may include a radio frequency (RF) object or a SAM object.

The method may further include, before the loading of the script: initializing the terminal; and receiving the script from a server.

The script may be selected according to an application to be performed by the terminal among a plurality of scripts stored in the terminal or provided by the server.

The method may further include returning a result of executing the script to the application.

According to another aspect of the present invention, it is possible to provide a terminal using a script. The terminal may include a script engine configured to provide a card processing object; a device driver for a device of the terminal; a memory; and a processing unit, wherein the processing unit loads a script including code calling the card processing object onto the memory, and executes the script by using the script engine to control the device driver. The card processing object may include a function for controlling the device driver. The function may be described in a Compiled language.

The card processing object may be formed by a Compiled language.

### Advantageous Effects

The present invention may provide a terminal technology that may dynamically add and change a function of an application of a radio frequency (RF) payment terminal by only a script file download operation without the compilation, installation and re-execution steps of source code.

### BRIEF DESCRIPTION OF THE DRAWINGS

FIG. 1 is a block diagram for explaining a terminal according to an embodiment of the present invention.

FIG. 2 represents a card processing process in a script based terminal according to an embodiment of the present invention.

FIG. 3 represents a detailed processing step of a script module according to an embodiment of the present invention.

FIG. 4 illustrates the relationship among a script file, a radio frequency (RF) object, and a SAM object included in a terminal according to an embodiment of the present invention.

FIG. 5 represents a portion of an application protocol data unit (APDU) command structure.

### MODE FOR CARRYING OUT THE INVENTION

Embodiments of the present invention are described below in detail with reference to the accompanying drawings so that a person skilled in the art may easily practice the present invention. However, the present invention may be implemented in many different forms and is not limited to embodiments that are described herein. The terms used herein are only intended to mention specific embodiments and not intended to limit the present invention.

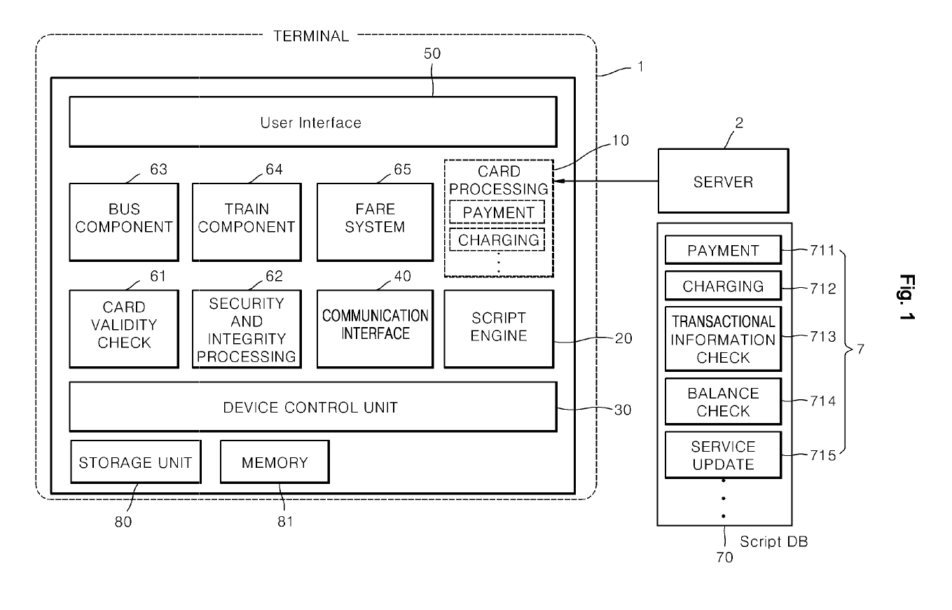

FIG. 1 is a block diagram for explaining a terminal according to an embodiment of the present invention.

A terminal 1 as represented in FIG. 1 may include a card processing unit 10, a script engine 20, a device control unit 30, a communication interface 40, and a user interface 50. In this case, the card processing unit 10 may process payment and charging functions related to an external electronic payment card that is accessed by using a radio frequency (RF) technology. In addition, the device control unit 30 may include an RF device control unit and a SAM device control unit. In this example, the user interface 50 may show a screen design to a user and receive an input from the user.

Also, the terminal 1 may include function modules, such as a card validity check unit 61 for card processing, a security and integrity processing unit 62, a bus component processing unit 63, a train component processing unit 64, and a fare system processing unit 65. Although not shown, the terminal 1 may further include a component processing unit for other transports, such as a taxi.

A server 2 may access a script database (DB) 70 that includes script files 71 or 711 to 715 for processing payment, charging, transactional information check, balance check, and service update functions related to an electronic payment card. Also, the server 2 may transmit any script included in the script DB 70 to the terminal 1 through the card processing unit 10 of the terminal. The script files 711 to 715 may also be transmitted to the terminal 1 by using a storage device such as a separate universal serial bus (USB) stick without using the server 2.

An embedded system is warren in a low level language such as C or C++ due to performance issue. However, in the case of processing a card conforming to an international standard such as ISO-7816 or ISO-14443, the same card item may be processed with an application protocol data unit (APDU) command, as in an embodiment of the present invention. In addition, a card processing function shows a little difference depending on the hardware or operating system (OS) of the terminal, and even in terms of a processing speed, a communication time between an RF device and a SAM device occupies more than a time consumed for processing a command. Thus, even when the card processing function is based on a script, it is possible to ensure a sufficient speed in comparison to when the function is implemented with C or C++.

When a payment function is additionally modified or when there is a need for an update due to version up, the script file based payment terminal system as shown in FIG. 1 may complete an update only when a script file is only downloaded form the server and replaced. Likewise, even when a function is added, it is possible to download a script file for a corresponding additional function from the server and execute the script file to perform the function when the corresponding additional function is needed.

In this case, it is possible to develop a new language as a script language and it is possible to develop and use a corresponding interpreter. Alternatively, it is possible to use the script engine 20 in FIG. 1. Spider Monkey or V8 may be used as the script engine 20, in which case it is possible to perform a program written in a standard script language such as JAVA script, based on the script engine.

It is possible to write, in a script language, typical card processing functions of applications executed on the terminal 1, such as payment, charging, transactional information check, balance check, and service update functions. The script file may be initially stored in the terminal 1 or downloaded from the server 2 and then stored in the terminal 1.

The script engine 20 may provide an RF object for card processing and a SAM object for card security processing. The script file 71 may use these objects to perform card processing operations such as payment and charging operations for a transportation card.

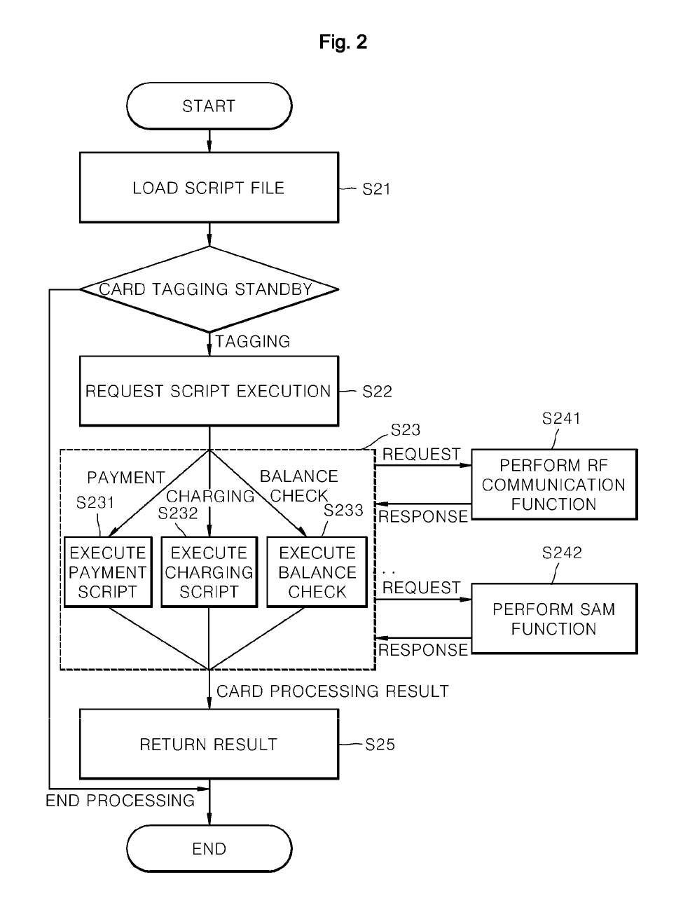

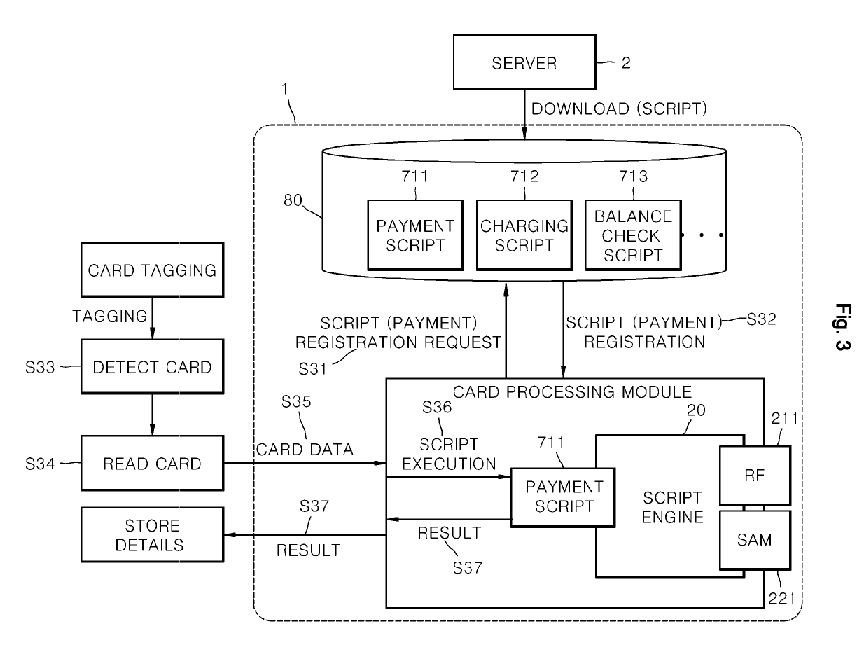

FIG. 2 represents a card processing process in a script based terminal according to an embodiment of the present invention.

In step S21, the terminal loads the script file 71 needed for card processing through an initialization process after booting. If the terminal 1 is a payment terminal, it is possible to load the payment function-script file 711 performing a payment function, and if the terminal is a charging terminal, it is possible to load the charging function-script file 712 performing a charging function. If the terminal is a terminal performing only a search function, it is possible to load the check-script file 713 performing a balance check function or transactional information check function. After function-dependent script files are loaded in this manner, the script file 71 matching a corresponding function is called and processed when there is a card tagging operation. The result may be returned to the application. Specifically, when a card is identified near the RF device in a card tagging standby state, it may be detected that there is the card and a process of reading data from the card may be performed.

In step S22, a request for executing the script file corresponding to the use (payment, charging or detail check) of the terminal based on data read from the card is implemented as described above. The script file 71 may be loaded when the terminal initially boots or while the terminal operates. In this case, the script file 71 loaded may also be downloaded from the server 2, for example.

In step S23, a corresponding script file 71 is executed. For example, when there is a need for performing a payment function, it is possible to perform a payment script in step S231, when there is a need for performing a charging function, it is possible to perform a charging script in step S232, and when there is a need for performing a balance check function, it is possible to perform a balance check script in step S233. When performing step S23, each script file for each function may request the RF object to provide an APDU command for communication with the card in an RF state and thus perform an RF communication function in step S241. Likewise, in step S242, the SAM object may provide a SAM communication function that is requested from the script file 71. Each script file 71 may be executed on the script engine 20. In step S25, a value generated as a result of performing a script may be returned to the application.

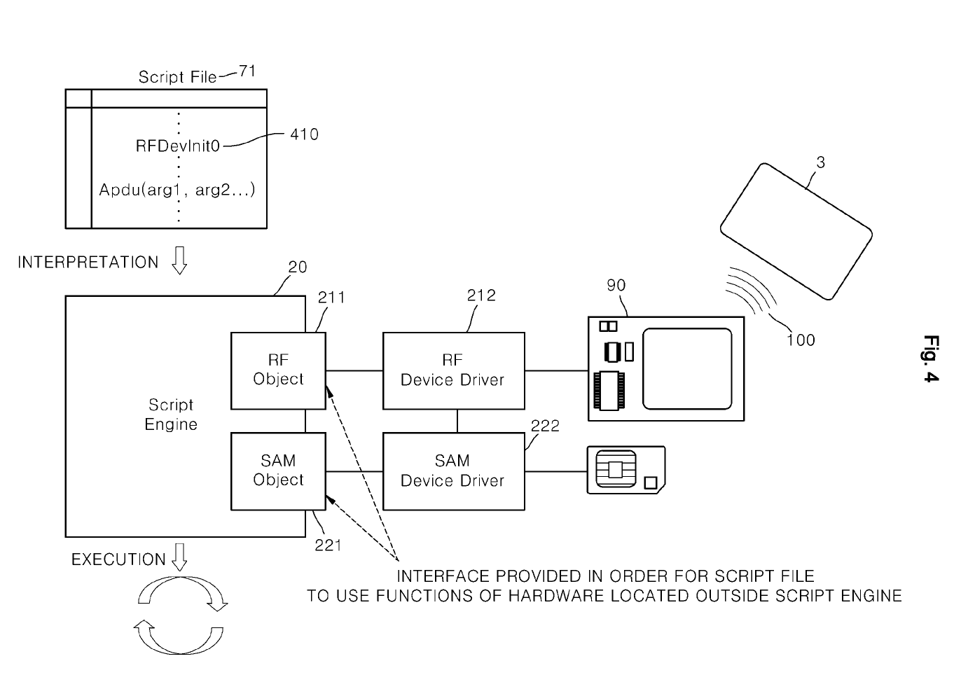

FIG. 3 represents a detailed processing step of a script module according to an embodiment of the present invention.

As described already in FIG. 2, the terminal 1 initializes the terminal 1 upon booting and then loads the scrip file 71 having a support function onto a memory. The script file 71 may be pre-stored in a disk (storage unit 80) or downloaded from the server 2. There may be many types of script files 71.

Referring to FIG. 3, in step S31, the card processing unit 10 of the terminal 1 may request to register (load) a script file corresponding to a necessary function with the memory 81 and/or the script engine 20 when the terminal 1 boots. In this case, the script files 711 to 713 may be stored in the storage unit 80 of the terminal 1 and stored script files 711 to 713 may also be received from the server 2.

Next, in step S32, corresponding script files 711 to 713 are searched for and loaded (registered) onto the memory 81 and/or the script engine 20. When loading is ended, a terminal system is ready for processing a card.

In this case, when a card is actually tagged near an RF antenna and detected in step S33, a read process S34 is performed and a request for performing a script is implemented in step S35.

The script engine 20 may provide card objects needed for processing a script file, such as an RF object and a SAM object. Also, as the script engine 20, it s possible to use a general-purpose JAVA script engine such as Rhino, Spider Monkey, or V8. Which script file 71 is called may be selected after determination on functions to be processed by an application.

In step S36, by using one or more script files 71 loaded onto the memory, it is possible to execute one or many script files 71 at one time. That is, it is possible to execute the payment script 711 and the balance check script 713 together and if there is a business receiving a charging commission, it is possible to execute the charging script 712 and then the payment script 711.

In step S37, a value generated as a result of executing the script may be stored.

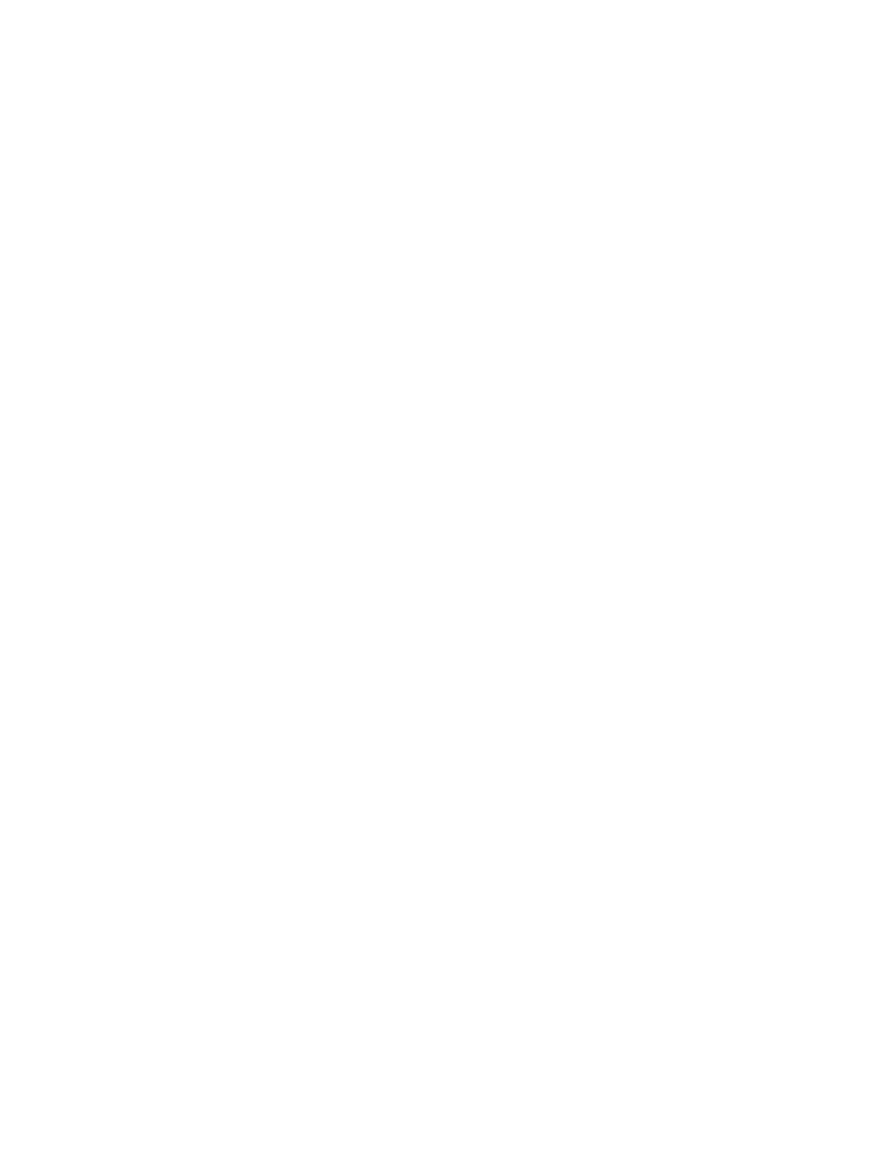

FIG. 4 illustrates the relationship among a script file, a radio frequency (RF) object, and a SAM object included in a terminal according to an embodiment of the present invention.

The script file 71 specifies code 410 representing operations written in order to perform specific functions. The script file 71 is executed on the terminal through the script engine 20. An RF payment terminal should control an RF device for card processing in a disconnected state and control a SAM device in order to perform security functions.

However, the script file 71 may not directly control pieces of hardware. Thus, it is possible to use hardware control codes written previously with C, C++, etc. Thus, the script engine 20 may provide the RF object 211 and/or the SAM object 221 to be capable of controlling an RF device driver and/or the SAM device driver located outside the script engine 20. That is, the RF/SAM objects 211 and 221 may be considered in the script file 71 as interfaces provided in order to use the functions of hardware located outside the script engine 20.

The script file 71 may control hardware by using an object provided by the script engine 20 and thus process a function for a card. For example, the RF object 211 controls an RF hardware 90 through the RF device driver 212 as shown in FIG. 4 and may thus transmit an APDU command 100 to a card 3 through RF communication and perform processing in response thereto.

The APDU command 100 is a command transmission standard for communication with the card 3. The APDU command 100 is roughly divided into two types. There is “command APDU” transmitted to perform a command for the card 3 by the terminal 1 and there is “response APDU” transmitted from the card 3 to the terminal 1ter the card 3 has processed a command. An APDU command protocol is regulated by international standard ISO 7816-4. The terminal uses the APDU protocol to perform commands provided by the card to perform card processing and accordingly, various RF payment terminal functions such as payment, charging and balance check functions are performed. An actual script file executes these APDU commands to perform card processing.

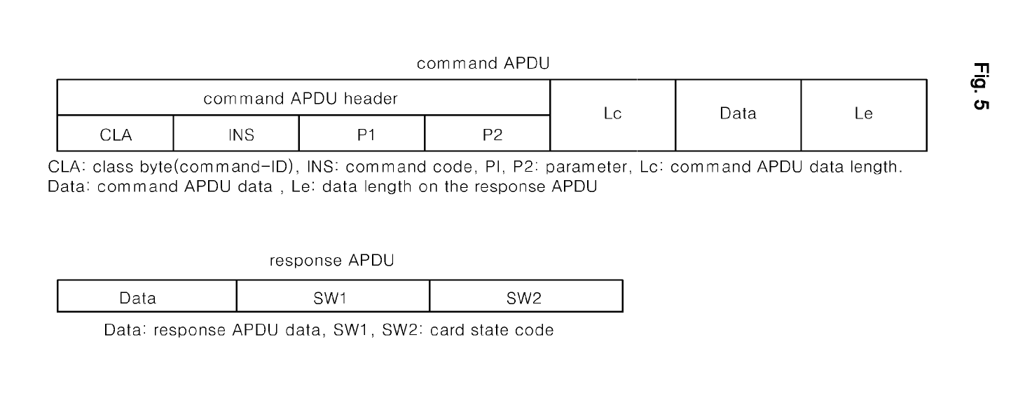

FIG. 5 represents a portion of an APDU command structure.

The “command APDU” includes a command APDU header including class byte (command-ID) CLA, command code INS, and parameters P1 and P2, command APDU data length Lc, command APDU data Data, and data length Le on the response APDU. The “response APDU” includes response Data and card state codes SW1 and SW2.

### Example of Script Code

<Table 1> is an example of a script file written with JAVA script to check a transportation card balance. Looking into the script, the RF device is initialized for card processing on line 3 and then the APDU command is performed for checking a balance on line 10. A result is checked on line 19 with reference to SW variables SW1 and SW2 returned after the processing of the APDU, and it is possible to check the balance by decoding a return value on line 27 when the return value of the APDU has been normally received. An exemplary script in <Table 1> is written with JAVA script conforming to an ECMA standard and to this end, JAVA script engines being commonly used on a web browser, such as Rhino, Spider Monkey and V8 may be used. For reference, the script file above has been executed without difficulty on Spider Monkey engine.

<Table 1> is an example of a simple script for checking balance but it is possible to implement a payment or charging function by further using SAM objects.

TABLE 1

```
Line 1:: load(“tools/wbsutil.js”);
Line 2:: // initializing RF device(RC531)
Line 3:: RfDevInit( );
Line 4:: var bCLA = 0x90;
Line 5:: var bINS = 0x4C;
Line 6:: var bP1 = 0x00;
Line 7:: var bP2 = 0x00;
Line 8:: var bLc = 0x00;
Line 9:: var bLe = 0x04;
Line 10:: var retVal = lapdu([bCLA, bINS, bP1, bP2, bLc,
        bLe])
Line 11:: print(“[0]” + retVal[0] + “, [1]” + retVal[1] +“,
        [2]” + retVal[2] +“, [3]” + retVal[3] );
Line 12:: // return value of APDU
Line 13:: var val1 = retVal[0];
Line 14:: var val2 = retVal[1];
Line 15:: var val3 = retVal[2];
Line 16:: var val4 = retVal[3];
Line 17:: var sw1 = retVal[4];
Line 18:: var sw2 = retVal[5];
Line 19:: print(“SW[0]:” + sw1 + “, SW[1]:” + sw2);
Line 20:: if(sw1 == 0 && sw2 == 0)
Line 21:: {
Line 22:: print(“APDU return value does not exist”);
Line 23::  }
Line 24:: else
Line 25::  {
Line 26:: sum = (val1 << 24) + (val2 << 16) + (val3 << 8) +
        val4;
Line 27:: print(“balance left in new card : ” + sum);
Line 28::  }
```

RfDevinit( ) and lapdu( ) in <Table 1> are functions calling an RF device. RfDevinit( ) is an RF device initialization function and lapdu( ) is a function transmitting an APDU command and receiving a return value. In particular, RfDevinit( ) is a function initializing the RF device (e.g., RC 531 module) and when initialization is completed, the terminal 1 and the card 3 may make contactless communication. When JAVA script 71 actually calls a corresponding initialization function RfDevlint( ), an initialization function written with C code is called and source code of the initialization function may be provided as in <Table 2> below.

TABLE 2

119 static JSBool
120 _RfDevInit(JSContext *cx, JSObject *obj, unitN argc,
jsval *argv, jsval *rval)
121 {
122 int rc;
123 int iResult;
124 int sresult;
127
128 CARD_BASIC_INFO stCardInfo;
129
130 iResult = RfDevInit(DEV_RF);
131
132 //registration of card of use..
133 CardAddRfType(CARD_RF_TYPE_ALL);
134 CardAddPlatformType(CARD_PLATFORM_TYPE_ALL);
135 . . . .
147 return JS_TRUE;
148 }

According to code in <Table 2>, an initialization process is performed in which a device is initialized on line 130 and a card to be used and a support platform type are registered on lines 133 and 134.

Next, the terminal 1 and the card 3 performs communication by using the APDU command and to this end, the script file 71 may use the lapdu( ) API function capable of being used in script, in which case a sendApduCard( ) function controlling a device may be called from C code. Source code of sendApduCard( ) is represented, for example, in <Table 3> below.

```
TABLE 3
60 int sendApduCard(APDU_DataType *adApduSend, APDU_DataType
  *adApduReceive)
61 {
62 int idx;
63 int nResult;
64
65 fprintf(gOutFile, “\nCard adApduSend...\n”);
66 for (idx = 0; adApduSend->length--; idx++)
67 {
68  fprintf(gOutFile,  “  [%d]=%d”,  idx,  adApduSend-
  >cbApduData[idx]);
69 }
70
71
72 // TODO: send & receive native C code hear
73
74 /////////////////////////////////////////
75 char abResBuf[MAX_APDU_SIZE];
76 unsigned char bResLen;
77 char abSW[2] = {0, };
78 RF_APDU stAPDU;
79
80 stAPDU.bCLA = adApduSend->cbApduData[0];
81 stAPDU.bINS = adApduSend->cbApduData[1];
82 stAPDU.bP1 = adApduSend->cbApduData[2];
83 stAPDU.bP2 = adApduSend->cbApduData[3];
84 stAPDU.bLc = adApduSend->cbApduData[4];
85 stAPDU.bLe = adApduSend->cbApduData[5];
88
89 // Send APDU command
90 nResult = RfSCSendApdu(&stAPDU, RF_APDU_CASE2,
91 adApduReceive->cbApduData,
92 &bResLen, abSW);
93
94 ////////////////////////
95
96 fprintf(gOutFile, “\nCard ApduReceived\n”);
97
98 if (nResult < 0) // error
99 {
100 adApduReceive->length = 0;
101 return nResult;
102 }
103
104
105 // namhw //////////////
106 adApduReceive->cbApduData[bResLen++] = abSW[0];
107 adApduReceive->cbApduData[bResLen++] = abSW[1];
108  adApduReceive->length = bResLen;  //  value increase by
    two because of SW value
109
110 nResult = adApduReceive->length;
111 ///////////////////////
112
113 return nResult; // error NO ~ −x
114 }
```

In source code in <Table 3>, RfSCSendApdu( ) function is called in order to finally transmit an APDU command so that the APDU command 100 is actually transmitted from the terminal 1 to the card 3 on line 90.

Functions such as TRfDevinit( ) initializing a device driver, TCardAddRfType( ) registering an RF type to support, and RfSCSendApdu( ) transmitting the APDU command that are called by the RF object 211 used in script, such as two functions, RfDevinit( ) and lapdu( ) as described in <Table 2> and <Table 3> are provided by the RF device driver 212. That is, the RF object 211 may function as interface between the script file 71 and the RF device driver 212. Likewise, the SAM object 221 may function as interface between the script file 71 and the SAM device driver 222.

SAM is a hardware module provided in a USIM type as represented in FIG. 4 and includes a unique key value of a corresponding card company. A bus fare terminal includes as many SAM modules as support card types, such as T-money card SAM, EB card SAM, Mybi card SAM, and bus association SAM. SAM includes a unique key value, which is used to perform a security function such as an operation of authenticating a corresponding card.

In an embodiment of the present invention, a method of replacing a card processing function of an RF payment terminal implemented with C or C++ with a script file based function is provided. In this case, the script file equally performs a function implemented with C previously and becomes the core of the function to be performed.

Also, in an embodiment of the present invention, it is possible to call a script file for a necessary function from C code as a library in C is called. A called script file may perform the same function as typical C code. Source codes represented in <Table 4> and <Table 5> represent examples of functions calling a script file in C (<Table 5> is continued from Table 4). When a filename of JAVA script to be performed is written to a parameter of execJSScript( ) function represented in <Table 4> and <Table 5>, a corresponding script may be performed. Accordingly, it is possible to execute a desired script file in C.

TABLE 4

366 int execJSScript( char *file_name )
367 {
368 FILE *fp;
369 char *jsBuf;
370
371 JSRuntime *rt;
372 JSContext *ctx;
373 JSObject *global;
374 JSBool ok;
375 jsval rval;
376
377 // Create a Runtime
378 rt = JS_NewRuntime(1024 * 1024);
379 if (rt == NULL) {
380 printf(“rt error ...\n”);
381 }
382
383 // Create a Context
384 ctx = JS_NewContext(rt, 4096);
385 if(ctx == NULL) {
386 printf(“ctx error...\n”);
387 }
388
389 // Create a Global Object
390 global = JS_NewObject(ctx, NULL, NULL, NULL);
391 if (global == NULL) {
392 printf(“global error...\n”);
393 }
394

TABLE 5

```
395  // Init
396  JS_InitStandardClasses(ctx, global);
397
398  // load a script file.
399  fp = fopen(file_name, “r”);
400
401  // get a size of script file.
402  fseek ( fp, 0, SEEK_END );
403  uintN size = ftell(fp);
404  fseek ( fp, 0, SEEK_SET );
405
406  jsBuf = malloc(size);
407  memset (jsBuf, ‘\0’, size);
408
409  // read a script file
410  fread( jsBuf, size, 1, fp);
411
412  JS_DefineFunction(ctx,  global,  “printTime”,
      PrintTime, 1, 0);
413  JS_DefineFunction(ctx,  global,  “print”,  Print,  1,
      0) ;
414
415  // Execution
416  ok = JS_EvaluateScript(ctx,  global,  jsBuf,  size,
      NULL,  0,  &rval);
417
418  JS_DestroyContext (ctx);
419  JS_DestroyRuntime(rt);
420  JS_ShutDown( );
421
422  free (jsBuf);
423  fclose (fp);
424
425  return 0;
426 }
```

According to an embodiment of the present invention, it is possible to flexibly process tasks such as a function change and function addition when an application for the terminal is developed. That is, only a fixed specific function is not performed like a typical RF payment terminal but a payment terminal may also be used as a charging terminal when a charging script is downloaded, and may also be used as a search terminal. As a result, a function of the terminal may be flexibly defined and thus it is possible to use RF payment terminals to be suitable for a varying business environment.

### Embodiment

### Method of Controlling Terminal

A method of controlling a terminal according to an embodiment of the present invention is described below.

The control method may be performed by the terminal 1 including the script engine 20 that provides a card processing object. In this case, the card processing object may be the RF object 211 or the SAM object 221, for example. The method may include loading the script 711, 712 or 713 including code calling the card processing object in step S32. The above script may be provided as script in <Table 1>, for example. Also, code calling the card processing object may be RfDevinit( ) or lapdu( ) in <Table 1>, for example. Next, the method may include executing the script 711, 712 or 713 by using the script engine 20 to control the device driver of the terminal 1. In this case, the device driver may be the RF device driver 212 or the SAM device driver 222, for example.

In this case, the card processing object may include a function for controlling the device driver. For example, the function may be a function such as TRfDevinit( ) in <Table 2> or RfSCSendApdu( ) in <Table 3>. In this case, such a function may be described in a Compiled language.

Also, the method may further include initializing the terminal 1 before loading the script 711, 712 or 713, and receiving the script 711, 712 or 713 from the server 2. That is, it is possible to externally receive the script 711, 712 or 713 as described above.

In this case, the script 711, 712 or 713 may be pre-stored in the terminal 1, or may be selected according to an application to be performed by the terminal 1 among a plurality of scripts that are provided by the server 2. For example, when it is assumed that the terminal 1 is a terminal to perform a card issuing application, 2) charging script may be selected among a plurality of scripts such as 1) payment script, 2) charging script and 3) balance check script to be loaded onto the memory or the script engine 20. In this case, the method of controlling the terminal may further include returning a result of executing a script to an application.

### Embodiment

### Terminal

A terminal according to an embodiment of the present invention relates to a terminal performing the method of controlling the terminal.

The terminal may include the script engine 20 providing a card processing object, a device driver for a device of a terminal 1 device (e.g., RF device driver or SAM device driver), a memory, and a processing unit. In this case, the processing unit loads a script including code calling the card processing object onto the memory, and executes the script by using the script engine to control the device driver. In this example, the processing unit may mean an arithmetic device included in the terminal 1. In addition, the terminal 1 may perform various functions described in embodiments of the method of controlling the terminal.

The present invention is not limited by the above-described embodiments.

Although exemplary embodiments of the present invention have been described, a person skilled in the art will be able to easily make various changes and modifications without departing from the essential property of the present invention. Each claim may be combined with any claims that are not dependent thereon, within a scope that may be understood through the specification.

Therefore, disclosed embodiments should be considered in descriptive sense only and not for purposes of limitation. The true scope of the present invention is defined not by the detailed description of the present invention but by the appended claims, and all differences within the scope equivalent thereto will be construed as being included in the present invention.

### EXPLANATION OF REFERENCE NUMBER IN THE FIGURES

| | |
|---|---|
| 1: terminal | 2: server |
| 3: card | 10: card processing unit |
| 20: script engine | 71: script files |
| 80: storage unit | 100: APDU command |
| 211: RF object | 221: SAM object |

1. A method of controlling a terminal, the method comprising:
loading a script including code calling a card processing object, at a terminal including a script engine providing the card processing object; and
executing the script by using the script engine at the terminal to control a device driver of the terminal.

2. The method of claim 1, wherein the card processing object comprises a function for controlling the device driver.

3. The method of claim 2, wherein the function is described in a Compiled language.

4. The method of claim 1, wherein the card processing object is formed by a Compiled language.

5. The method of claim 1, wherein the card processing object comprises a radio frequency (RF) object or a SAM object.

6. The method of claim 1, further comprising, before the loading of the script: initializing the terminal; and receiving the script from a server.

7. The method of claim 1, wherein the script is selected according to an application to be performed by the terminal among a plurality of scripts stored in the terminal or provided by the server.

8. The method of claim 7, further comprising returning a result of executing the script to the application.

9. A terminal using a script, the terminal comprising:
a script engine configured to provide a card processing object;
a device driver for a device of the terminal;
a memory; and
a processing unit,
wherein the processing unit loads a script including code calling the card processing object onto the memory, and executes the script by using the script engine to control the device driver.

10. The terminal of claim 9, wherein the card processing object comprises a function for controlling the device driver.

11. The terminal of claim 10, wherein the function is described in a Compiled language.

12. The terminal of claim 9, wherein the card processing object is formed by a Compiled language.
